(19) United States
(12) Patent Application Publication
(10) Pub. No.: US 2025/0227590 A1
(43) Pub. Date: Jul. 10, 2025

(54) FRAMEWORK FOR DYNAMIC SLICE TRAFFIC OFFLOADING FOR WIRELESS NETWORKS

(71) Applicant: T-MOBILE INNOVATIONS LLC, Overland Park, KS (US)

(72) Inventors: Ming Shan Kwok, Seattle, WA (US); Antoine T. Tran, Sammamish, WA (US); Wafik Abdelshahid, Kenmore, WA (US); Hang Hoi Yau, Sammamish, WA (US)

(21) Appl. No.: 18/408,248

(22) Filed: Jan. 9, 2024

(51) Int. Cl. H04W 36/22; H04W 36/14

(52) U.S. Cl. CPC H04W 36/22; H04W 36/14

(57) ABSTRACT

Technology is disclosed herein for a negotiation framework by which a wireless network can negotiate with another network to dynamically offload data traffic corresponding to a network slice hosted by the wireless network. In an implementation, the wireless network determines that data traffic of a network slice is to be offloaded from the wireless network to another network. The wireless network identifies a visited network to host the data traffic and makes an offer to the visited network based on a negotiation framework which includes parameters for an agreement to offload the data traffic. When the visited network accepts the offer, the wireless network offloads the data traffic from the wireless network to the visited network.

### TECHNICAL FIELD

Aspects of the disclosure are related to the field of wireless network communication and, in particular, to managing data traffic and roaming.

### BACKGROUND

Software-defined networking along with network function virtualization enables fifth generation (5G) networks to provision their resources according to network slices. Network slices are allocations of network resources which are configured to support different service level requirements for different types of connected devices and their uses. For example, autonomous vehicles require ultra-reliable low-latency connectivity, while for video streaming, bandwidth and throughput will be more important than latency. Because network slices of a given network will share the same physical infrastructure of the network, however, they are subject to the same risks with regard to the infrastructure. For example, in an emergency situation, such as a natural disaster, the network in the area of the emergency may face a sudden increase in network traffic which can cause a degradation in performance with respect to some or all of the slices supported by the network.

Network reliability can be enhanced in some respects by network interoperability. Interoperability of wireless carrier networks enables continuous connectivity by allowing users to seamlessly migrate from network to another. This interoperability is enabled by roaming agreements between wireless communication carriers which enable subscriber devices to access voice, text, and data services while outside their home network's coverage area. Through these agreements, network operators agree on terms such as service rates, billing processes, and technical specifications to facilitate interoperability. In this way, roaming enhances the user experience by ensuring continuous connectivity. However, the quality of service may vary depending on the specifics of the agreements and the infrastructure of the visited network. When a user roams onto a visited network, the user may receive only a baseline level of service in accordance with the roaming agreement between the user's home network and the visited network.

### Overview

Technology is disclosed herein for a negotiation framework by which a wireless network can negotiate with another network to dynamically offload data traffic corresponding to a network slice of multiple network slices hosted by the wireless network. In an implementation, the wireless network determines that data traffic of a network slice is to be offloaded from the wireless network to another network. The wireless network identifies a visited network to host the data traffic of the network slice and makes an offer to the visited network based on a negotiation framework which includes parameters for an agreement to offload the data traffic. When the visited network accepts the offer, the wireless network offloads the data traffic of the network slice from the wireless network to the visited network.

In an implementation, the parameters of the negotiation framework include Quality of Service parameters associated with the network slice, location, duration, a number of active subscribers, and cost. In some implementations, the wireless network identifies the visited network based on a discovery of the visited network by a user device in communication with the wireless network. In some implementations, the visited network may be a non-cellular network.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for dynamic offloading of network slice data traffic of a wireless network in an implementation.

FIG. 2 illustrates a process for dynamic offloading of network slice data traffic of a wireless network in an implementation.

FIG. 3 illustrates a wireless communication system for dynamic offloading of network slice data traffic of a wireless network in an implementation.

FIG. 4 illustrates a workflow for dynamic offloading of network slice data traffic of a wireless network in an implementation.

FIG. 5 illustrates an operational scenario for dynamic offloading of network slice data traffic of a wireless network in an implementation.

FIG. 6 illustrates a workflow for dynamic offloading of network slice data traffic of a wireless network in an implementation.

FIG. 7 illustrates a wireless network architecture in an implementation.

FIG. 8 illustrates a computing system suitable for implementing the various operational environments, architectures, processes, scenarios, and sequences discussed below with respect to the other Figures.

### DETAILED DESCRIPTION

Various implementations are disclosed herein for a system for dynamically managing network data traffic on per-slice basis, where data traffic for a network slice is offloaded from one network to another on an ad hoc basis according to a negotiated agreement between the networks. In this way, network slice traffic can be temporarily offloaded from one network to another network that has sufficient idle capacity, with the offloading occurring at a negotiated rate for a limited duration. Enabling ad hoc offloading can provide greater flexibility in load balancing and traffic management, leading to improved network reliability as well as network slice Quality of Service (QOS). For example, in a scenario where a network suffers an outage or unanticipated spike in demand, the network can shift a portion of its data traffic to another network by the slice under a negotiated agreement which ensures the QoS for its offloaded subscribers according to that slice. Similarly, a network with idle capacity can accept an offer to temporarily handle slice traffic of another network, thus realizing revenue from the otherwise unused network capacity.

In an implementation, a framework is established amongst multiple networks whereby one network can make an offer to offload a portion of its network data traffic to another network on an ad hoc basis and according to a specified network slice for a limited period of time. According to the framework, the offer from the home network to a visited or roaming network specifies a location (e.g., coverage area of a particular Radio Access Node (RAN)), various QoS parameters (e.g., bandwidth, priority level, latency, throughput), duration of time during which offloading will occur, offer price or rate to be paid to the roaming network in exchange for hosting the slice traffic, and quantity of active subscribers for which service is to be provided. The roaming network operator can accept or reject the offer or make a counteroffer with adjusted parameters. When an agreement is reached, the home network offloads the traffic specified in the offer to the roaming network which hosts the traffic for the specified duration. Offloading slice traffic includes shifting data traffic of active subscribers from one network to another cellular or non-cellular network. The home network may also reject registration requests of subscriber devices for service corresponding to the offloaded network slice causing those subscriber devices to register with the roaming network hosting the offloaded slice data traffic.

Technical effects of the technology disclosed herein include improved flexibility in network management by providing the ability to dynamically offload network slice traffic while ensuring that its offloaded subscribers receive the Quality of Service to which they are entitled or which they would receive absent the offloading. The ability to dynamically offload slice traffic is facilitated by a negotiation framework established amongst multiple networks which includes a number of terms by which the networks can configure, receive, consider, and act on an offer to receive offloaded traffic. In this way, a network with idle capacity can monetize that capacity by contracting it out to another network on a limited basis, and networks seeking to manage data traffic to maintain or improve their network performance can avail themselves of available capacity of other networks according to a negotiated agreement.

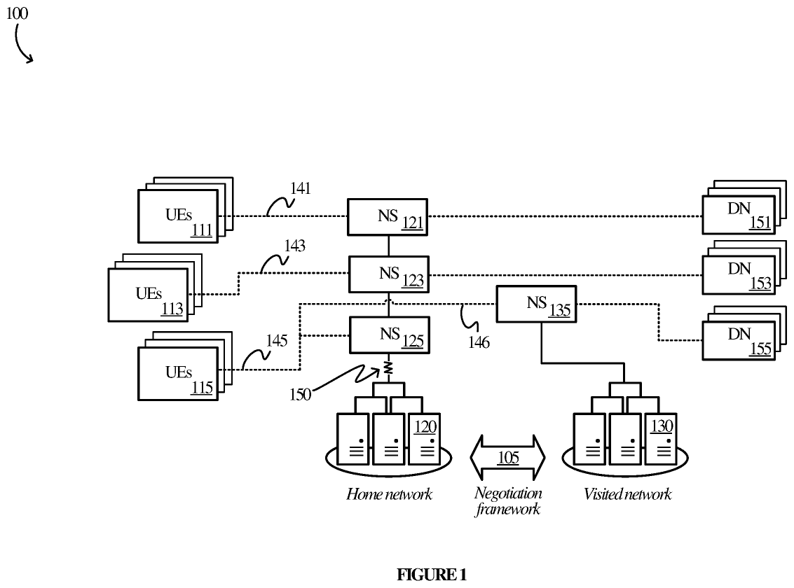

Turning now to the Figures, FIG. 1 illustrates operational environment 100 for dynamic traffic overloading according to a negotiation framework for network service providers in an implementation. Operational environment 100 includes home network 120 and visited network 130. Home network 120 hosts user equipment (UEs) 111, 113, and 115 according to resource allocations of network slices 121, 123, and 125. Network slices 121, 123, 125 are representative of allocations of network resources for carrying data traffic to data networks 151, 153, and 155, respectively. Visited network 130 hosts network slice 135.

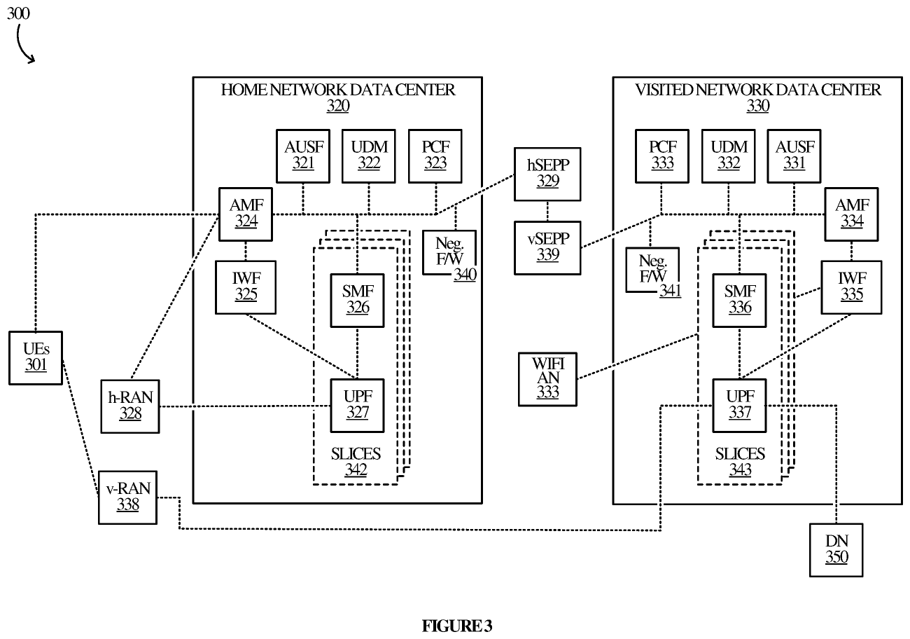

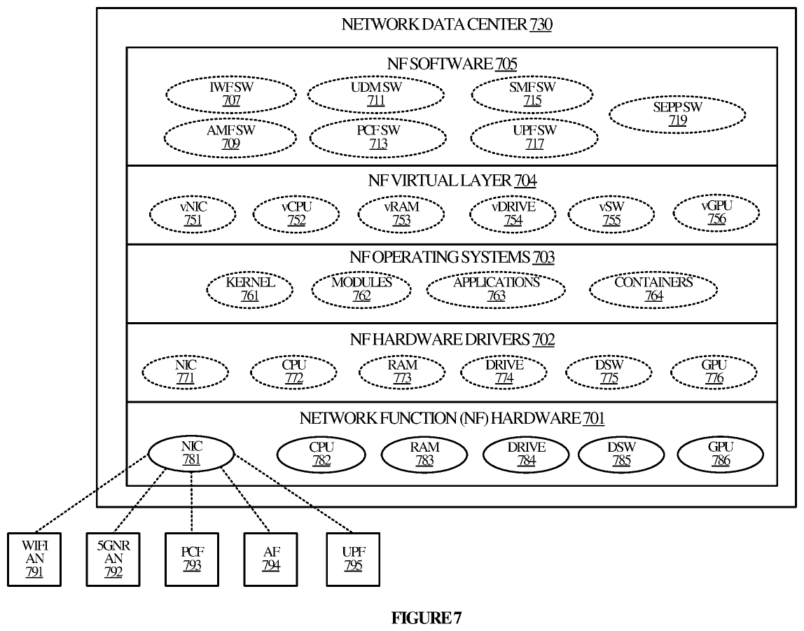

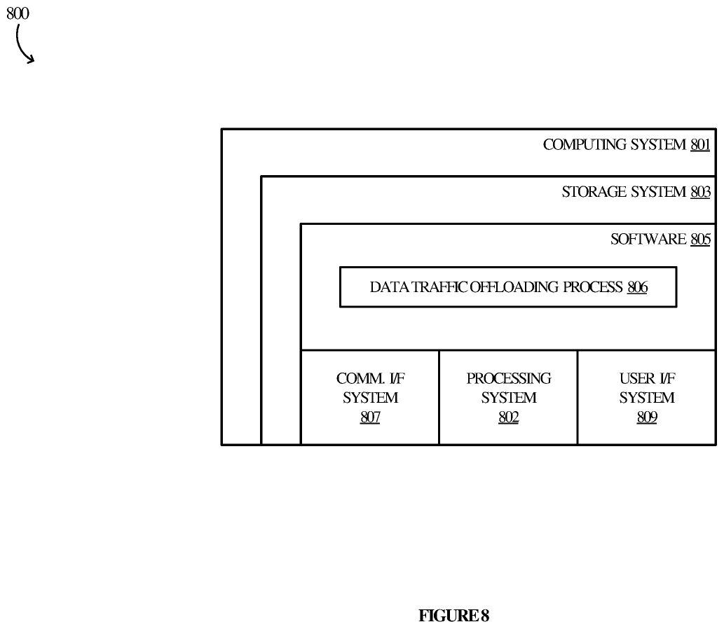

Home network 120 is representative of a communication network capable of using a Fifth Generation New Radio (5G-NR), LTE, 6G, or other protocol to communicate with UEs 111, 113, and 115. In an implementation, home network 120 is representative of a service-based architecture (SBA) which includes network functions which constitute the control plane and user plane of a wireless communication network core, of which home network data center 320 of FIG. 3 and network data center 730 of FIG. 7 are representative. The network functions of home network 120 are implemented on one or more suitable computing devices, of which computing device 801 of FIG. 8 is representative. Examples of suitable computing devices include server computers, blade servers, and the like. The network elements of home network 120 may be implemented in the context of one or more data centers in a co-located or distributed manner, or in some other arrangement. Visited network 130 is representative of a communication network capable of communicating with UEs 111, 113, and 115 via a cellular protocol (e.g., 5G-NR, 4G LTE, etc.) or a non-cellular protocol (e.g., Wifi).

Negotiation framework 105 is representative of an inter-network business interface by which network operators can exchange offers and counteroffers relating to ad hoc traffic offloading. In some implementations, negotiation framework 105 may be implemented by network servers and Security Edge Protection Proxies (SEPPs) of the respective networks communicating via the n32 interface. The SEPPs of the networks support an IP exchange (IPX) for inter-network communication. More specifically, an IPX is an architecture which interconnects various types of service providers, such as mobile operators, fixed operators, and Internet service providers, for exchanging IP data traffic. In an IPX scenario, the IPX acts as an intermediary between home network 120, visited network 130, and possibly other networks to support network interconnection, including bilateral and multilateral connection, using a Network-to-Network Interface (NNI). Thus, the IPX can facilitated negotiations according to negotiation framework 105.

UEs 111, 113, and 115 are representative of devices, such as smartphones, computers, sensors, controllers, radios, and/or some other user apparatus, with processing circuitry for wireless communication with home network 120 using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UEs 111, 113, and 115 can include devices such as Internet of Things (IoT) devices, wearable devices, smart vehicles, robots, sensors, augmented or virtual reality devices, and the like. UEs 111, 113, and 115 exchange wireless communication signals with access nodes of home network 120 over radio frequency bands.

Network slices 121, 123, 125, and 135 are representative of instances of network resource allocations operating on the physical network infrastructure of the wireless communication network. Each slice has a dedicated allocation of resources, such as bandwidth, processing power, and security, that is managed independently of the other slices. Each slice may be optimized for a particular type of use, such as low-latency, high reliability service for industrial automation or high-bandwidth service for video streaming. Network slicing also accommodates the separation of service providers and infrastructure providers. The control plane (not shown) of home network 120 manages network slicing and network slice selection, that is, selecting the appropriate slice of network slices 121, 123, and 125 for UEs 111, 113, and 115 based on their respective requirements.

Data networks (DNS) 151, 153, and 155 are representative of locations or destinations of communication pathways 141, 143, 145, and 146 originating from or terminating at UEs 111, 113, and 115. DNs 151, 153, and 155 include endpoints or destinations for IMS communication, such as a voice call, SMS, video call, or other IMS transmission. DNs 151, 153, and 155 may include communication networks operated by entities different from the entity or entities operating home network 120, such as service provider services, Internet access, third-party services, or enterprise resources.

In a brief illustration of an operational scenario of operational environment 100, home network 120 supports data or communication from UEs 111, 113, 115 to various ones of DNs 151, 153, and 155 along communication pathways 141, 143, and 145 hosted by home network 120. At some point in time, service event 150 occurs, representative of a disruption of network data service, such as a localized outage, a sharp increase in data traffic, or other event which impacts the ability of home network 120 to service UEs 111, 113, and/or 115. In various scenarios, home network 120 may prioritize network slices 121 and 123 for service and seek to offload lower-priority traffic of network slice 125 to alleviate the demand on its resources. For example, network slice 121 may correspond to Wireless Priority Service (WPS), a high-priority service which would not be a candidate for offloading. Home network 120 solicits visited network 130 to carry the traffic of network slice 125 by making an offer via negotiation framework 105 for ad hoc traffic offloading. For example, visited network 130 may be a Wifi network to which home network 120 determines to offload its lowest priority data traffic, that which corresponds to network slice 125.

Visited network 130 receives the offer to host data traffic of network slice 125 from home network 120. Visited network 130 may accept the offer outright or negotiate the terms or parameters of the offer. When an agreement is reached, home network 120 routes data traffic corresponding to network slice 125 to be carried along communication path 146 hosted by visited network 130. Visited network 130 carries the traffic according to network slice 135 comprising visited network 130's resources allocated according to the negotiated parameters. Visited network 130 continues to host the data traffic of UEs 115 for the time period specified in the agreement. When the time period of the agreement expires, home network 120 may resume carrying the data traffic of UEs 115 according to network slice 125. If, however, the need for offloading continues beyond the term of the agreement, home network 120 may negotiate an extension of the agreement or a second agreement by which visited network 130 or another service provider continues hosting the offloaded slice traffic.

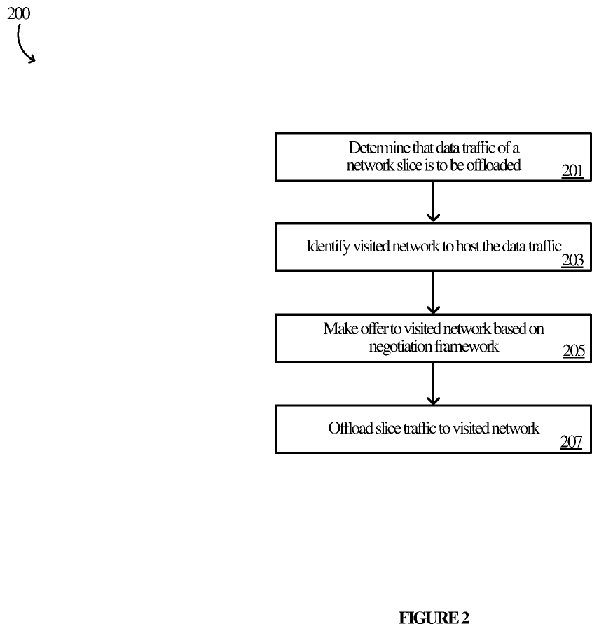

FIG. 2 illustrates process 200 for operating a wireless network including ad hoc offloading of data traffic according to a network slice of the traffic in an implementation, herein referred to as process 200. Process 200 may be implemented on one or more computing devices, such as server computers or computers in the context of a network data center, according to program instructions which direct the computing devices to function as follows, referring parenthetically to the steps in FIG. 2 and in the singular for clarity.

A wireless network hosting multiple network slices determines that data traffic of a network slice is to be offloaded (step 201). In an implementation, a network element of the RAN or core of the wireless network detects anomalous performance, such as a sharp uptick in traffic congestion or a network outage. The wireless network determines that to maintain an adequate level of service for its subscribers, that data traffic associated with one or more network slices is to be offloaded to alleviate congestion on the network, thereby preserving the Quality of Service for its subscribers. For example, the wireless network may determine that its active subscribers of the to-be-offloaded network slice for a particular geographic region or location are to be diverted to another network. In some scenarios, the wireless network may anticipate a need for traffic offloading before it occurs. For example, the network operator may determine that use of the network will be unusually high in the vicinity of a large public event. The network operator may determine that data traffic corresponding to one or more network slices is to be offloaded in anticipation of the upcoming heightened demand.

The wireless network identifies a visited network to handle the slice traffic (step 203). In an implementation, the wireless network may receive information about other available networks by polling user devices in the vicinity of a service disruption or outage, such as obtaining public land mobile network (PLMN) identifiers or CGI information identifying other networks from subscriber devices. The wireless network may then solicit the other networks with offers for hosting the to-be-offloaded traffic. In an implementation, the wireless network receives information from the other networks regarding capability or available capacity to support the to-be-offloaded slice traffic. In some instances, the wireless network may consider prior experience in deciding which network(s) to solicit for offloading data traffic to a network, including whether the visited network performed adequately in the past, how quickly or easily the visited network can receive the traffic offload, and so on. Other networks to which traffic can be offloaded can include IP networks such as cellular or non-cellular networks.

Having identified one or more visited networks, the network element makes an offer to a visited network to accept slice traffic (step 205). In an implementation, the wireless network makes an offer to the visited network to host the network slice traffic via a framework for negotiating ad hoc traffic offloading between networks. In its offer, the wireless network specifies a number of parameters relating to the traffic to be offloaded along with a price or rate of compensation to be paid to the visited network. The offer may specify performance parameters relating to Quality of Service, bandwidth, throughput, latency, reliability, and packet loss. The offer may also specify the quantity of subscribers to be supported and a period of time for hosting the slice traffic. The offer may also specify the geographic location where the traffic is to be offloaded, such as identifying the RANs where traffic will be diverted to the visited network. In some scenarios, the offer may reference terms of preexisting Service Level Agreements (SLAs) between the networks. In some scenarios, the wireless network may transmit its offer to multiple other networks which may respond with bids, acceptances, rejections, or counteroffers.

In some scenarios, the framework for negotiating a dynamic traffic offload occurs via an IP backbone or exchange (IPX) which facilitates inter-network communication between the wireless network and the visited network and possibly other networks. The IPX is hosted by the SEPPs of the wireless and visited networks which communicate over the n32 interface of the 5G-NR architecture. The SEPPs, in turn, communicate with servers of the respective networks which execute the negotiation framework for dynamic traffic offloading.

In an implementation, the wireless network transmits an offer configured by its negotiation framework server to the visited network via an IPX hosted by the respective SEPPs. The visited network executes its instance of the negotiation framework to evaluate the offer parameters with respect to its available capacity and cost for hosting the traffic. The visited network may submit a counteroffer via the IPX which the wireless network can similarly evaluate.

The negotiation framework executing on a server of a given network can configure offers for dynamic traffic offloading and consider offers received from other networks seeking to offload traffic. More specifically, the negotiation framework operates to configure and receive offers which include multiple parameters defined in the framework by which the wireless network can specify the service it desires or can offer and the compensation it is offering or expects to receive for the service. In some implementations, offers, acceptances, counteroffers, and so on, may be configured as data structures such as JSON objects with predetermined key-value pairs corresponding to the framework parameters. Transmission of the JavaScript Object Notation (JSON) objects may occur via an application programming interface (API) hosted by the receiving network.

When an agreement is reached for offloading the slice traffic, the wireless network offloads the slice traffic to the visited network (step 207). In an implementation, the wireless network identifies data traffic for offloading according to the resources allocated to the traffic and steers the traffic to the visited network. To steer the traffic of active subscribers to the visited network, the RAN to which the subscriber devices are connected may communicate with the core of the visited network, such as with the Access and Mobility Function (AMF) of the visited network, to initiate a handover process for the current subscribers. When a new subscriber of the offloaded slice attempts to connect to the wireless network, the network rejects the request which allows the subscriber device to connect to the visited network per the terms of the agreement.

Referring again to FIG. 1, operational environment 100 illustrates a brief example of process 200 as employed by elements of operational environment 100. In operation, home network 120 hosts UEs 111, 113, and 115 according to network slices 121, 123, and 125, respectively.

At some point in time, service event 150 occurs during which home network 120 suffers a disruption or degradation of service. In response to service event 150, home network 120 determines which traffic of network slices 121, 123, and 125 should be offloaded to alleviate demand on the network to maintain service for its active subscribers. Home network 120 determines that traffic network slice 125 as lower priority data traffic which can be offloaded to another network to alleviate demand. In some scenarios, determining which slice to traffic to offload may be based additionally or alternatively on the traffic volume of the slice.

Home network 120 identifies visited network 130 as having the capability or capacity to handle traffic of network slice 125. To identify visited network 130, home network 120 may poll various ones of UEs 111, 113, and/or 115 to determine which networks might be available for offloading, e.g., visited network 130. Through negotiation framework 105, home network 120 makes an offer to visited network 130 to host the traffic. Visited network 130 receives the offer and negotiates an agreement to host the traffic. The terms of the offer and the agreement include performance parameters specific to network slice 125 (e.g., QoS parameters, bandwidth, etc.) along with parameters relating to the hosting, such as a number of active subscribers to be serviced, a duration of the offloading, and a location. The terms also include charging information, such as a price or rate of compensation for hosting the offloaded subscribers.

With an agreement in place, UEs 115 of network slice 125 are diverted to visited network 130 which hosts the traffic via network resources allocated to network slice 135, a slice commensurate in performance with network slice 125. With traffic of UEs 115 now carried on communication path 146 hosted by visited network 130, the load carried by home network 120 is now lessened, allowing the network to maintain the requisite level of service for the remaining network slices 121 and 123.

FIG. 3 illustrates exemplary wireless communication system 300 including network data centers for home and visited networks for dynamic traffic offloading of network slice traffic in an implementation. Wireless communication system 300 includes UEs 301, home network data center 320, and visited network data center 330. Home network data center 320 includes various network functions such as Authentication Server Function (AUSF) 321, Unified Data Management (UDM) 322, Policy Control Function (PCF) 323, Interworking Function (IWF) 325, Session Management Function (SMF) 326, and User Plane Function (UPF) 327. IWF 325 includes non-3GPP IWFs (N3IWFs) for providing untrusted non-3GPP access to home network data center 320, such as access via a non-cellular access network. Wireless network slices 342 of home network data center 320 represent allocations of network resources of the home network of home network data center 320; protocol data unit (PDU) sessions of the various slices of network slices 342 are hosted by UPF 327 and SMF 326. Home network data center 320 includes other network functions not shown for the sake of clarity. In an implementation, UE 301 is a subscriber device of the network operator associated with home network data center 320 and can connect with AMF 324 for service via Radio Access Node (h-RAN) 328. h-RAN 328 includes elements of a g-NodeB stack, such as radio units, distributed units, and central units, by which UEs 301 can register with home network data center 320 for service.

Visited network data center 320 of wireless communication system 300 includes Authentication Server Function (AUSF) 331, Unified Data Management (UDM) 332, Policy Control Function (PCF) 333, Interworking Function (IWF) 335, Session Management Function (SMF) 336, and User Plane Function (UPF) 337. IWF 335 includes non-3GPP IWFs (N3IWFs) for providing untrusted non-3GPP access to visited network data center 320, such as access via a Wifi access node (AN) 333. Wireless network slices 343 of visited network data center 330 are hosted by UPF 337 and SMF 336. Visited network data center 330 includes other network functions not shown for the sake of clarity. UE 301 can connect with AMF 334 of visited network data center 330 for service via v-RAN 338. Data network (DN) 350 is representative of a destination or endpoint of a data path hosted by visited network data center 330 (e.g., by local breakout).

Home network data center 320 and visited network data center 330 can communicate via their respective SEPPs, hSEPP 329 and vSEPP 339, to execute negotiations per a negotiation framework for dynamic traffic offloading. SEPPs, such as hSEPP 329 and vSEPP 339, are network functions which act as security gateways to protect the network edge by serving as a proxy of communication with other networks. As security gateways, SEPPs perform functions such as authentication and authorization checks and inspecting and filtering data traffic. The negotiation framework, of negotiation framework 105 of FIG. 1 is representative, may execute on negotiation framework servers 340 and 341 of the respective networks, although in some implementations, the negotiation frameworks may execute on other network elements or functions of the respective networks.

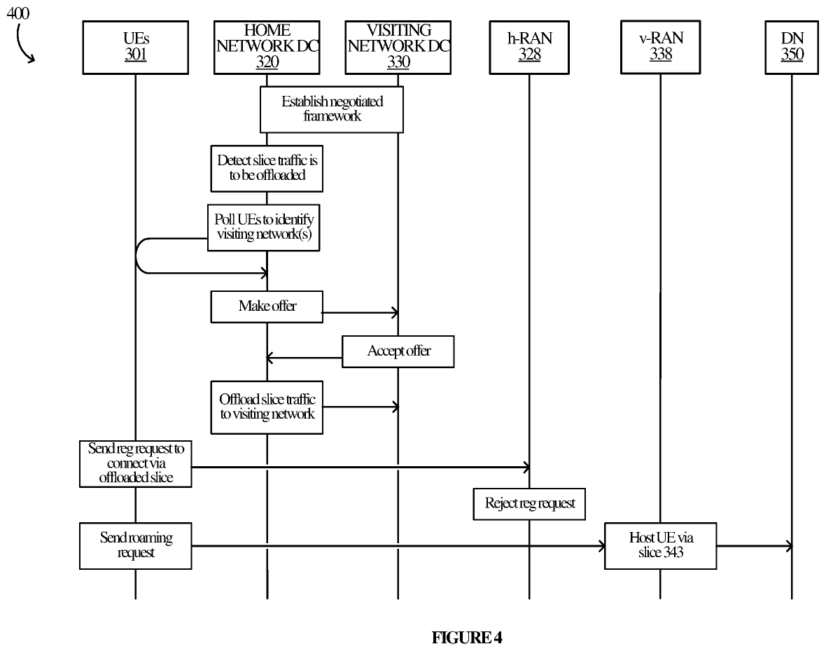

FIG. 4 illustrates workflow 400 for dynamic offloading of network slice traffic in an implementation, referring to elements of wireless communication system 300 of FIG. 3. Workflow 400 illustrates processes employed by a network operator to dynamically offload data traffic for one or more network slices of network slices 342 to the network hosted by visited network data center 330.

In workflow 400, a negotiation framework for ad hoc offloading of data traffic by network slice has been established between the network operators of home network data center 320 and visited network data center 330. The established framework allows one network to solicit service from another network for hosting traffic of a network slice. The framework may be hosted on negotiation framework servers 340 and 341 of the respective networks; offers, acceptances, or other exchanges relating to the negotiation framework are communicated via hSEPP 329 and vSEPP 339.

In an operational scenario, the network operator of home network data center 320 determines that data traffic of one or more network slices is to be offloaded to another network For example, the network operator may detect degraded performance parameters or KPIs relating to network performance which may be due to an increase or imbalance in traffic loading, a local disruption or outage, or other event. In some scenarios, however, processes of workflow 400 may be instigated in anticipation of scenario where the network will be subjected to significantly increased demand, planned or anticipated outage, etc.

Home network data center 320 polls UEs 301 in the vicinity or location where data traffic is to be offloaded, such as the location of the service disruption. In polling UEs 301, the network operator determines which other networks are available, including cellular and non-cellular networks, based on the networks discovered by UEs 301. Upon detecting that the visited network of visited network data center 330 is available to UEs 301, the home network determines which of network slices 342 it wishes to offload. For example, the home network may determine to offload one or more lower priority network slices on the basis of factors such as: the cost to offload the lower priority slices, the amount of traffic or subscribers (active and/or anticipated) of the slice that will be offloaded, the subscription level of the subscriber devices to be offloaded (e.g., the home network may wish to maintain service for subscriber devices of higher-priority business plans by offloading lower-priority slice traffic), the capability of the visited network to host the various network slices, prior experience in offloading network slice traffic to the visited network, and so on.

When the home network determines that one or more of network slices 342 are to be offloaded, an offer is configured via negotiation framework server 340. Negotiation framework server 340 configures a data object including the terms of the offer. The offer terms include several parameters relating to performance requirements for the slice(s) to be offloaded (e.g., QoS parameters), the logistics of the offloading (e.g., where, for how long, for how many subscribers), and the cost. With an offer configured, hSEPP 329 transmits the data object to vSEPP 339 of the visited network, for example, via an API hosted by the visited network.

Upon receiving the offer via vSEPP 339, the visited network makes a determination to accept the offer. The visited network returns, via vSEPP 339, an acceptance of the offer. The home network proceeds to steer active subscribers for the to-be-offloaded slices to the visited network which begins hosting those subscribers according to the performance parameters specified in the offer. In this way, the home network can ensure that the offloaded subscribers are receiving the Quality of Service for their network slice.

Continuing workflow 400, one or more of UEs 301 attempts to connect to the home network via h-RAN 328. Upon determining that the devices are seeking to connect according to the offloaded network slice, h-RAN 328 rejects the attempts to connect. UEs 301 then send a roaming request to connect with v-RAN 338 of the visited network which registers the devices for connection per the negotiated agreement. UEs 301 are then able to connect with various endpoints or destinations of DN 350.

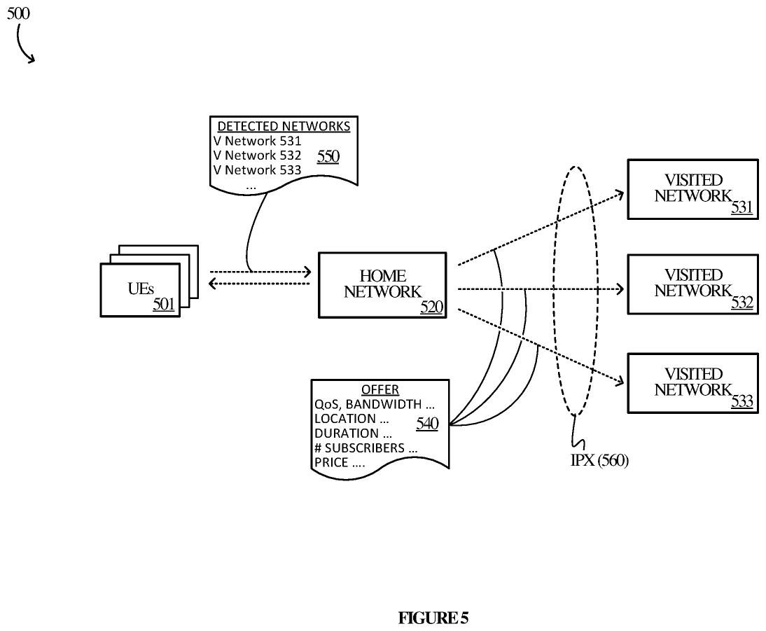

FIG. 5 illustrates operational scenario 500 for dynamic offloading of network slice traffic in an implementation. Operational scenario 500 includes home network 520, of which home network 120 of FIG. 1 is representative, and UEs 501. Home network 520 communicates with visited networks 531, 532, and 533, of which visited network 130 of FIG. 1 is representative, for the purpose of negotiating an agreement to offload the slice traffic. Communication between home network 520 and visited networks 531, 532, and 533 is conducted via IPX 560, including sending offer 540 for hosting the to-be-offloaded slice traffic. In operational scenario 500, a framework for negotiations pertaining to ad hoc network traffic offloading has been established and may be implemented via inter-network communication through IPX 560.

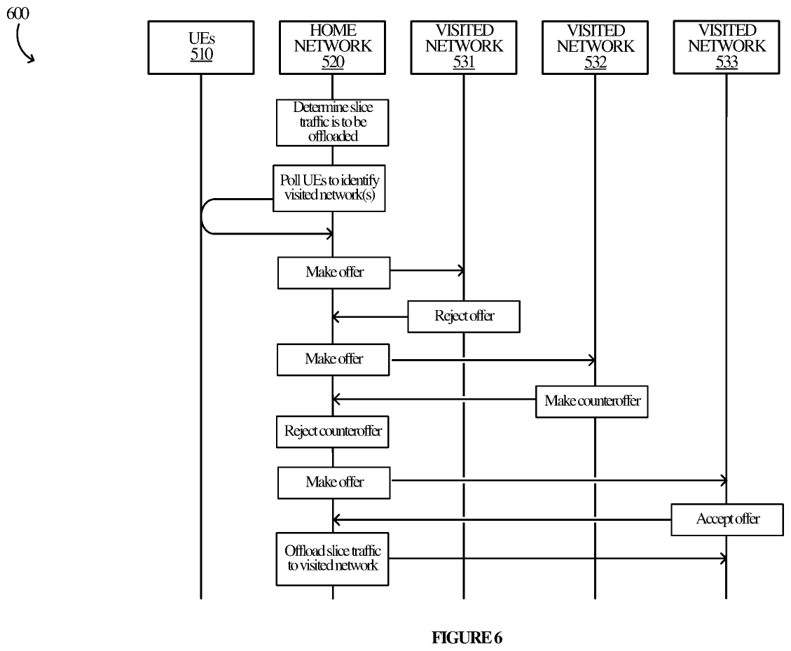

FIG. 6 illustrates workflow 600 for dynamic offloading of network slice traffic in an implementation, referring to elements of operational scenario 500. In workflow 600, home network 520 determines that data traffic of UEs 510 for a given one or more network slices hosted by home network 520 is to be offloaded. Home network 520 determines which other networks may be available for hosting the to-be-offloaded traffic by pinging or polling UEs 510 for identification of networks discovered by UEs 301. UEs 510 return detected network information 550 by which home network 520 determines that visited networks 531, 532, and 533 are candidates for hosting the to-be-offloaded traffic.

In an implementation, home network 520 configures offer 540 per the negotiation framework established amongst home network 520 and visited networks 531, 532, and 533. Home network 520 determines an order by which to transmit offer 540 to the various ones of visited networks 531, 532, and 533. The order for sending a series of offers to multiple networks may be determined on the other networks' available capacity, prior experience, or previous agreement. Home network 520 determines to send a first instance of offer 540 to visited network 531. Visited network 531 transmits a rejection of the offer, and home network 520 sends a second instance of offer 540 to visited network 532. Visited network 532 receives offer 540 and returns a counteroffer which modifies one or more terms of offer 540. Home network 520 receives the counteroffer but rejects it and may return a notification of the rejection to visited network 532. Home network 520 then sends a third instance of offer 540 to visited network 533 which accepts the offer and returns a notification of the acceptance to home network 520. When the acceptance is received, home network 520 offloads the specified slice traffic to visited network 533 per the terms of the agreement.

FIG. 7 illustrates exemplary network data center 730, a network core of a wireless communication system, of which home network 120 of FIG. 1 is representative. Network data center 730 includes network function (NF) software 705, network function virtual layer 704, network function operating systems 703, network function hardware drivers 702, and network function hardware 701.

Network function software 705 of network data center 730 includes software for executing various network functions: IWF software 707, AMF software 709, UDM software 711, PCF software 713, SMF software 715, UPF software 717, and SEPP software 719. Other network function software, such as network repository function (NRF) software, are typically present but are omitted for clarity.

Network function virtual layer 704 includes virtualized components of network data center 730, such as virtual NIC 751, virtual CPU 752, virtual RAM 753, virtual drive 754, virtual software 755, and virtual GPU 756. Network operating systems 703 includes components for operating network data center 730 including kernels 761, modules 762, applications 763, and containers 764 for network function software execution. Network function hardware drivers 702 include software for operating network function hardware 701 of network data center 730, including network interface card (NIC) drivers 771 for network interface cards (NICs) 781, CPU drivers 772 for CPUs 782, RAM drivers 773 for RAM 783, flash/disk drive drivers 774 for flash/disk drives 784, data switch (DSW) drivers 775 for data switches 785, and drivers 776 for GPUs 786. Network interface cards 781 of network function hardware 701 include hardware components for communicating with Wifi access node 791, 5GNR access node 792, PCF 793, application server 794, and UPF 795.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements data traffic offloading process 806, which is (are) representative of the data traffic offloading processes discussed with respect to the preceding Figures, such as process 200. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including data traffic offloading process 806) may be implemented in program instructions and among other functions may, when executed by processing system 802, direct processing system 802 to operate as described with respect to the various operational scenarios, sequences, and processes illustrated herein. For example, software 805 may include program instructions for implementing a data traffic offloading process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support dynamic offloading of data traffic in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of operating a wireless network hosting multiple network slices, comprising:
determining that data traffic of a network slice of the multiple network slices is to be offloaded from the wireless network to another network;
identifying a visited network to host the data traffic of the network slice;
making an offer to the visited network based on a negotiation framework to host the data traffic of the network slice of the wireless network, wherein the negotiation framework comprises parameters for an agreement to offload the data traffic of the network slice from the wireless network to the visited network; and
when the visited network accepts the offer, offloading the data traffic of the network slice from the wireless network to the visited network.

2. The method of operating the wireless network of claim 1, wherein the parameters include Quality of Service parameters associated with the network slice.

3. The method of operating the wireless network of claim 2, wherein the parameters further include: location, duration, number of active subscribers, and a cost.

4. The method of operating the wireless network of claim 2, wherein identifying the visited network comprises identifying the visited network based on a discovery of the visited network by a user device in communication with the wireless network.

5. The method of operating the wireless network of claim 4, wherein the visited network comprises a non-cellular network.

6. The method of operating the wireless network of claim 1, further comprising identifying a plurality of visited networks and selecting the visited network from among the plurality of visited networks based on a capacity of the visited network with respect to the data traffic of the network slice to be offloaded.

7. The method of operating the wireless network of claim 1, wherein determining that the data traffic is to be offloaded is based on a priority of the network slice.

8. The method of operating the wireless network of claim 1, wherein determining that the data traffic is to be offloaded is based on a traffic volume of the network slice.

9. The method of operating the wireless network of claim 1, wherein making the offer to the visited network comprises transmitting the offer to the visited network via an n32 interface between a Security Edge Protection Proxy (SEPP) of the wireless network and the SEPP of the visited network.

10. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
with respect to a wireless network hosting multiple network slices:
determine that data traffic of a network slice of the multiple network slices is to be offloaded from the wireless network to another network;
identify a visited network to host the data traffic of the network slice;
make an offer to the visited network based on a negotiation framework to host the data traffic of the network slice of the wireless network, wherein the negotiation framework comprises parameters for an agreement to offload the data traffic of the network slice from the wireless network to the visited network; and
when the visited network accepts the offer, offload the data traffic of the network slice from the wireless network to the visited network.

11. The computing apparatus of claim 10, wherein the parameters include: Quality of Service parameters associated with the network slice, location, duration, number of active subscribers, and cost.

12. The computing apparatus of claim 11, wherein to identify the visited network, the program instructions direct the computing apparatus to identify the visited network based on a discovery of the visited network by a user device in communication with the wireless network.

13. The computing apparatus of claim 10, wherein the visited network comprises a non-cellular network.

14. The computing apparatus of claim 10, wherein the program instructions further direct the computing apparatus to identify a plurality of visited networks and select the visited network from among the plurality of visited networks based on a capacity of the visited network relative to the network slice to be offloaded.

15. The computing apparatus of claim 10, wherein to determine that the data traffic is to be offloaded, the program instructions direct the computing apparatus to determine that the data traffic of the network slice is to be offloaded based on a priority of the network slice.

16. The computing apparatus of claim 10, wherein to make the offer to the visited network, the program instructions direct the computing apparatus to transmit the offer to the visited network via an n32 interface between a Security Edge Protection Proxy (SEPP) of the wireless network and the SEPP of the visited network.

17. One or more computer readable storage media having program instructions stored thereon that, when executed by one or more processors, direct a computing device to at least:
with respect to a wireless network hosting multiple network slices:
determine that data traffic of a network slice of the multiple network slices is to be offloaded from the wireless network to another network;
identify a visited network to host the data traffic of the network slice;
make an offer to the visited network based on a negotiation framework to receive the data traffic of the network slice of the wireless network, wherein the negotiation framework comprises parameters for an agreement to offload the data traffic of the network slice from the wireless network to the visited network; and
when the visited network accepts the offer, offload the data traffic of the network slice from the wireless network to the visited network.

18. The one or more computer readable storage media of claim 17, wherein the parameters include: Quality of Service parameters associated with the network slice, location, duration, number of active subscribers, and cost.

19. The one or more computer readable storage media of claim 18, wherein to identify the visited network, the program instructions direct the computing device to identify the visited network based on a discovery of the visited network by a user device in communication with the wireless network.

20. The one or more computer readable storage media of claim 19, wherein the program instructions further direct the computing device to identify a plurality of visited networks and select the visited network from among the plurality of visited networks based on a capacity of the visited network relative to the network slice to be offloaded.
